(19) United States
(12) Patent Application Publication
(10) Pub. No.: US 2007/0112899 A1
(43) Pub. Date: May 17, 2007

(54) Method and apparatus for fast boot of an operating system

(76) Inventors: Matthew F. Edwards, Baltimore, MD (US); Daron R. Underwood, Canton, MI (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/273,265

(22) Filed: Nov. 14, 2005

(51) Int. Cl. G06F 17/30; G06F 12/00

(52) U.S. Cl. 707/205; 707/200

(57) ABSTRACT

A computer system is adapted for rapid booting to any one of plural contexts such as that of a desktop application or television application. The system may be booted to an initial state in one context by reading a write-protected hibernate file into RAM and registers. The system may be initialized into another context by means of that hibernate file in conjunction with a difference file.

### BACKGROUND OF THE INVENTION

After power is applied to a computer system, the system typically performs some initial testing of the hardware and then proceeds to boot the operating system from a non-volatile storage device. Booting involves loading and initializing system components, including the operating system kernel. The initialization process takes a significant amount of time, so it can take several minutes to boot the operating system. After the operating system has been successfully booted, application programs can be opened and executed on the computer system.

In recent years, standard CPUs and operating systems typically used in desktop applications have been extended to other applications. For example, the Microsoft Windows XP® operating system may be used to control more sophisticated processes of today's televisions and to control application specific devices such as X-ray systems or other medical devices. The users of such systems are accustomed to prompt starting and are thus not tolerant of the long system start up times to which desktop application users have been exposed.

An approach to speeding the boot process in such applications has been to rely on the hibernate function that is available in many operating systems. Many operating systems such as Microsoft's Windows 2K/XP/2003 and Linux support a hibernate function that reduces power consumption in the computer system while the user is not using the computer system. The hibernate function may use the Advanced Configuration and Power Interface (ACPI) technology that is included in the Basic Input

Output System (BIOS). ACPI defines different power states including hibernation, standby and shutdown.

When in the hibernation state, the state of the computer system is saved, including the state of all open files and documents prior to powering down the computer system. After restoring power to the computer system, the operating system restores the computer system to the saved state with the documents and files open on the system as they were prior to hibernation. Thus, applications, documents and browser pages are available soon after power is restored to the system. Without the hibernation function, it could take several minutes to boot the operating system and reopen applications and documents.

With the hibernate function, prior to shutdown, the system stores a state file of the system registers and random access memory. During start up, the system reads that stored hibernate file and loads the image directly into the RAM and registers, thus avoiding the lengthy initiation process. After the system resumes operation based on the hibernate file, that file is typically marked as dirty, thus requiring a complete rebooting of the system before the hibernate function can be relied upon again. To overcome that limitation, system software has been modified to maintain the hibernate file in a protected state such that the system can always be re-booted promptly to that defined system state.

### SUMMARY OF THE INVENTION

CPUs and associated operating systems can be used for more than one application in a single hardware environment. For example, a single system may be used as a television or a desktop computer. In accordance with one aspect of the present invention, booting of the operating system is dependant on the context in which the system is to operate, such as an application, so that the initialized system is in a preferred state for that context. In order to provide rapid booting to any of plural contexts, plural state files are stored in non-volatile memory, each file for restoring the system to a respective state. During booting of the operating system, state file is selected based on the context in which the system is to operate. The loading of the Operating System is steered in such a way as to boot the OS into the selected state. The state may, for example, be selected based on user input during startup, as through a keystroke or infrared remote controller, or it may be based on user input during prior processing.

In accordance with another aspect of the invention, initialization to one of the plural states is enabled by saving, in non-volatile memory, a base state file, such as a hibernate file, and a difference file relative to the base state file for a different system state. The system boots to the different system state by steering to the difference file and the base state file to place volatile memory at an initial state.

There may be plural selectable difference files. In illustrative embodiments, the hibernate resume process is modified to check for context specific difference files and to redirect the hibernate file operations during initialization where indicated. In certain systems, the state files are protected against overwriting during system use. However, a difference file may be based on system state during processing. A difference file may be replaced during system processing, or a file may be added during processing.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a simplified block diagram of a computer system embodying in the present invention.

FIG. 2A is a simplified flow chart of a conventional hibernate boot process.

FIG. 2B is a simplified flow chart of a modification of the final step of FIG. 2A in accordance with the present invention.

FIG. 3 is a simplified flow chart of a process used by a manufacturer in storing hibernate and hibernate difference files for use with the present invention.

### DETAILED DESCRIPTION OF THE INVENTION

A description of preferred embodiments of the invention follows.

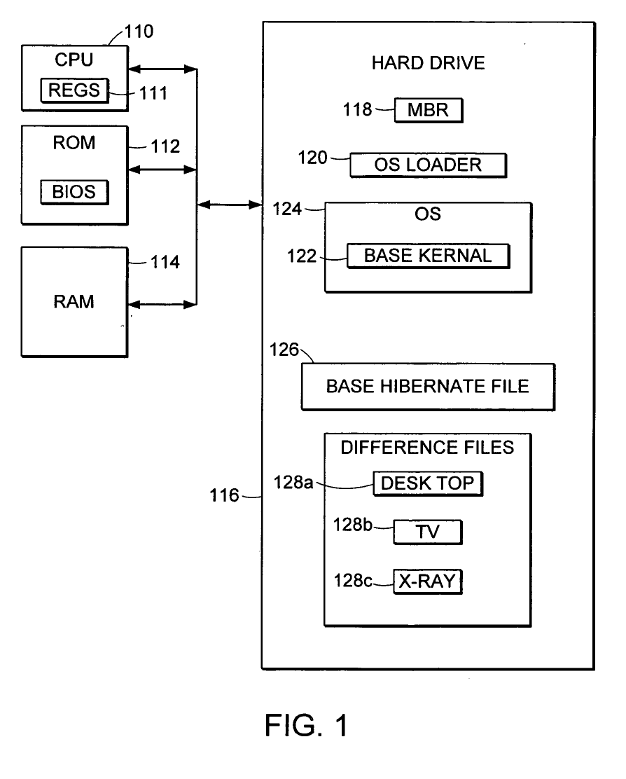

FIG. 1 illustrates a conventional computer system modified in accordance with aspects of the present invention. A CPU 110 having registers 111 processes data from a nonvolatile read only memory (ROM) 112 and volatile random access memory (RAM) 114. Random access memory provides for fast operation, but the data stored therein is lost during shutdown. Nonvolatile memory 116, such as a hard drive, maintains the large amounts of programs and data required by the system even during shutdown. Portions of that data are transferred into the RAM 114 during operation as needed. Other forms of nonvolatile memory which may be relied upon in practicing the invention include tape drives, CD ROMs and the like.

To boot the operating system, the CPU first looks to a basic input output system (BIOS) stored in ROM 112. The BIOS calls on instructions stored in the hard drive to load the operating system and initialize the operating system and other components. Those instructions, including portions of the operating system read from the hard drive, are written into the volatile memory 114. As the user then uses the computer system, loading and processing application programs such as electronic mail applications and word processing applications, both volatile and nonvolatile memory are modified. At any point during operation of the system, its operating state is determined by the contents of the RAM 114, file system state of nonvolatile memory, and data in registers 111 of the CPU. All of the data stored in the volatile RAM and registers is lost when power is turned off.

As noted above, some operating systems, such as those that use advanced configuration and power interface (ACPI) technology, include a hibernate function. The system is described relative to Windows-based systems, such as the Windows Xp® system, but it will be understood that the system may be applied to modifications of any number of operating systems, including those that do not have a hibernate function.

With the hibernate function, the system stores the operating state, that is the contents of RAM 114 and of the CPU registers 111, prior to shutdown. Thereafter, during the reboot, the system can avoid the time consuming initialization process by copying that stored state file back into the RAM and registers so that the system can continue operation from the point at which the state files were stored.

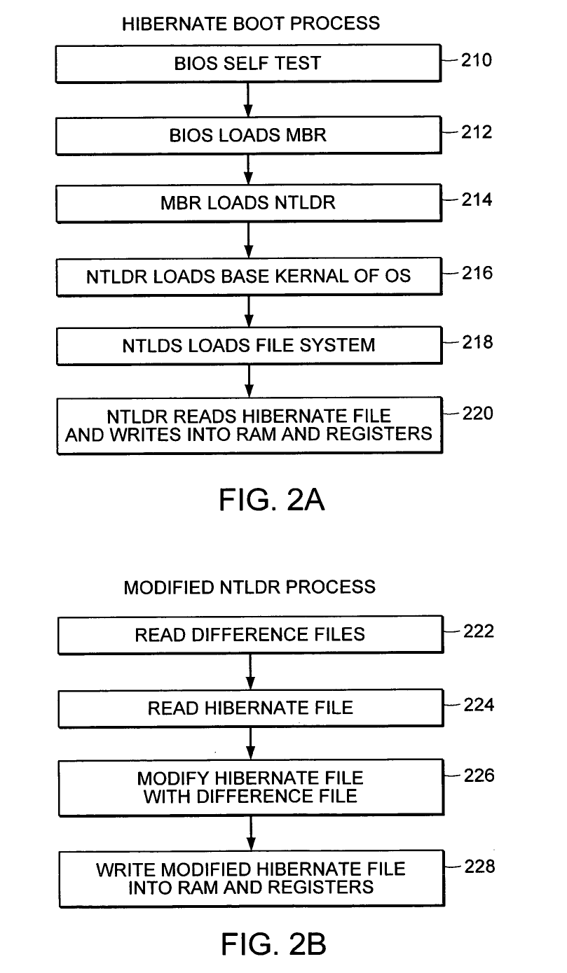

A typical resume boot process from hibernate is illustrated in FIG. 2A with further reference to FIG. 1. As the system reboots, the BIOS system is read from ROM 112 and begins a power on self-test (POST). The BIOS then loads the master boot record (MBR) 118 at 212. Code in the MBR is processed until an operating system loader 120 is loaded into RAM at 214. In Windows XP® systems that loader software is referred to as NTLDR. The loader 120 is then processed to load the base kernel 122 of the operating system 124 at 216. It also loads a file system such as NTFS at 218. In a conventional boot process, the operating system loader and base kernal would continue to be processed by the CPU to fully initialize the system. However, in systems having the hibernate function, the operating system loader looks to a hibernate file 126, and if that data is valid, the system relies on the state stored in the hibernate file to initialize the data in RAM 114 and the CPU registers 111 at 220.

Whereas the hibernate file in a typical system is dynamic and dependant on the state of the system resulting from user processing, in order to rely on that file as a defined initialization state for rapid booting, the operating system is modified to protect the hibernate file from modification. As such, the hibernate (state) file may be created and stored by the OEM that installs system software during the manufacturing process to serve as a secure initialization point from which the system may always be booted. As a further modification, in accordance with the present invention, plural hibernate files are stored in the nonvolatile memory in order that the system may boot into various contexts. For example, one hibernate file would be stored such that the system can be promptly booted to a television context and another hibernate file may be created and stored such that the system can be rapidly booted to a desktop context. Other application contexts such as that of an x-ray machine controller may also be included.

To more efficiently store and process the plural hibernate files, without storing multiple complete files, the system of FIG. 1 includes one base hibernate file 126 and plural difference files 128a, 128b, and 128c, each for a different system context. The base hibernate file may initiate one context and the differences between that context and each additional context are then stored in the difference files. During initialization, the system is notified of the desired context and the OS loader 120 processes the hibernate and difference files according to the desired context. The selection of context is fully extensible by the OEM. For example, one of the function keys may be pressed during startup to identify the context, or the system may respond to an infrared control input from a remote controller. Additionally the context may be set by software during the previous boot, or the context might be selected by a set of matching conditions hardware or software.

To implement the invention using the difference files, the step 220 of FIG. 2A can be modified as illustrated in FIG. 2B. When a defined context is indicated, by user or software input, the OS loader looks at the appropriate difference file, here named hiberdiff.sys, at 222. At 224, the loader reads the base hibernate file, designated hiberfil.sys. At 226, the loader modifies the base hibernate file with the difference file to create state file to be used in initiating the system. That modified hibernate file is written into RAM 114 and the registers 111 at 228.

With the modified hibernate file, the system begins at a desired state that would likely include an open application program, such as a word processing program in a desktop application or a medical application program in the case of a medical device.

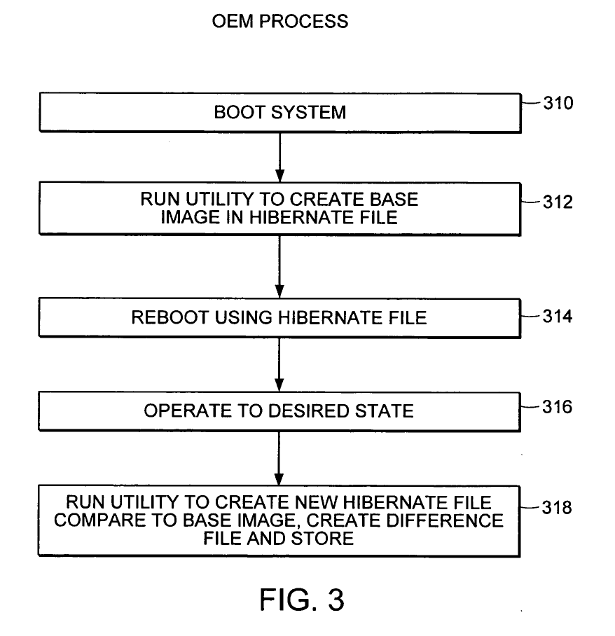

Although the hibernate files may be created and stored by a user, in most applications it will be the manufacturer who will create and store the hibernate files along with the system software. One method for creating such files is presented in FIG. 3. At 310, the system is booted in the conventional way with no hibernation files present. At 312, the creator runs a utility to create the base state file in hiberfil.sys. The system is then shutdown and re-booted using the stored hiberfil.sys file 314. The system is then operated until it reaches a desired state. For example, a desired application program may be opened and processed until the system reaches a state at which the manufacturer intends the system to always begin when in a particular context. At 318, the creator again runs a utility to create a new hiberfil.sys file, to compare that new file to the base state file and to then create the hiberdif.sys files. The base state file created at 312 and the difference files created at 318 are then stored in the nonvolatile memory for access during booting. Of course, the files created on one machine may then be duplicated into any number of installations.

Different initial states may be dependent on a user's access rights. For example, one state may be used for classified data and programs and another for unclassified data and programs.

An Operating System installation creates a specific directory structure on the boot device and populates that structure with all the files which make up the OS. This file and directory structure is typically required by the OS to properly boot into the OS upon application of power to the system. The present system allows booting of this installation of the OS in such a way as to give a different look to the boot process and the resulting booted system. However, although the system appears to be different based on the chosen boot state, the OS files used in the boot process are still from the single OS installation.

In one implementation, once the system boots to one of the captured states, the changes to the system which occur due to system operations and user activity are stored in a volatile location. That is to say, when the session is ended and the system is powered down, the changes made during the session are lost. And upon next reboot into that captured state, the system is exactly as it was before the user activity.

In a further implementation, the user can select to boot into more than one captured state. After doing so, the user activity is cached as before; however, the user can choose to make that activity data be stored into a persistent, non-volatile device, so as to extend the state file for the given context. In this scenario, the user now powers off the system and the activity data is not lost. Upon power application, the user selects that same state to boot, except now the previously made changes are integrated into the state and this system look exactly as it did when last powered off.

To make this more clear, an example is provided. The scenario is that a user boots to a word processing state. The system boots and the user is presented immediately with a word processor which contains a blank document and is ready to accept input. The user types in a letter and chooses to save the document without closing the document in the word processor. Now the user powers off the system.

Under the first implementation, when the user applies power and boots back into the word processor state, the system is just as before, a blank document and no evidence that the user ever typed in a letter. With the further implementation, upon reboot, not only would the word processor be available, but the previously typed letter would be open with the word processor.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of booting a data processing system comprising:
providing plural state files in nonvolatile memory for restoring the system to respective states corresponding to plural processing applications; and
during booting of the system, selecting state file based a selected application in which the system is to operate.

2. A method as claimed in claim 1, wherein an state file is stored as a difference file relative to a base state file.

3. A method as claimed in claim 2, wherein the base state file is stored in a hibernate files accessed during booting of the system.

4. A method as claimed in claim 1, wherein applications to be selected include a desktop application and a television application.

5. A method as claimed in claim 1, further comprising protecting the state files against being overwritten during processing.

6. A method as claimed in claim 1, wherein the plural state files are provided by a system software installer.

7. A method as claimed in claim 1, wherein a state file is selected based on user input during startup.

8. A method as claimed in claim 1, wherein a state file is selected based on user input during prior processing.

9. A data processing system comprising:
plural state files in nonvolatile memory for restoring the system to respective states corresponding to plural processing applications; and
booting software that selects a state file based on a selected application in which the system is to operate.

10. A system as claimed in claim 9, wherein a state file is stored as a difference file relative to a base state file.

11. A system as claimed in claim 10, wherein the base state file is stored in a hibernate files accessed during booting of the system.

12. A system as claimed in claim 9, wherein applications to be selected include a desktop application and a television application.

13. A system as claimed in claim 9, further wherein the state files are protected against being overwritten during processing.

14. A system as claimed in claim 9, wherein the plural state files are provided by a system software installer.

15. A system as claimed in claim 9, wherein a state file is selected based on user input during startup.

16. A system as claimed in claim 9, wherein a state file is selected based on user input during prior processing.

17. A method of initializing a data processing system, comprising:
saving in nonvolatile memory a base state file for a base system state;
saving in nonvolatile memory a difference file relative to the base state file for a different system state; and
booting to the different system state by steering the system to the difference file and base state file to place volatile memory at an initial state.

18. A method as claimed in claim 17, wherein the state files are stored in hibernate files accessed during booting of the system.

19. A method as claimed in claim 17, wherein the system is steered based on a selected context.

20. A method as claimed in claim 17, further comprising protecting the state files against being overwritten during processing.

21. A method as claimed in claim 17, wherein the base state file and difference are provided by a system software installer.

22. A method as claimed in claim 17, wherein the system is booted to a system state based on a selected application.

23. A method as claimed in claim 17, wherein a state file is selected based on user input during startup.

24. A method as claimed in claim 17, wherein a state file is selected based on user input during prior processing.

25. A method as claimed in claim 17, wherein a difference file is stored based on system state during processing.

26. A method as claimed in claim 25, wherein a difference file is replaced during system processing.

27. A method as claimed in claim 25, wherein a difference files is added during system processing.

28. A method as claimed in claim 17 further comprising saving plural selectable difference files.

29. A data processing system comprising:
a base state file stored in nonvolatile memory for a base system state;
a difference file relative to the base state file stored in nonvolatile memory for a different system state; and
a booting system to boot to the different system state by steering the system to the difference file and base state file to place volatile memory at an initial state.

30. A system as claimed in claim 29, wherein the base state file is stored in a hibernate file accessed during booting of the system.

31. A system as claimed in claim 29, wherein the system is steered based on a selected context.

32. A system as claimed in claim 29, wherein the state files are protected against being overwritten during processing.

33. A system as claimed in claim 29, wherein the base state file and difference file are provided by a system software installer.

34. A system as claimed in claim 29, wherein the system is booted to a system state based on a selected application.

35. A system as claimed in claim 29, wherein a difference file is selected based on user input during startup.

36. A system as claimed in claim 29, wherein a difference file is selected based on user input during prior processing.

37. A system as claimed in claim 29, wherein a difference file is stored based on system state during processing.

38. A system as claimed in claim 37, wherein a difference file is replaced during system processing.

39. A system as claimed in claim 37, wherein a difference file is added during system processing.

40. A system as claimed in claim 29 further comprising plural selectable difference files stored in nonvolatile memory.
